(19) United States
(12) Patent Application Publication
(10) Pub. No.: US 2016/0087851 A1
(43) Pub. Date: Mar. 24, 2016

(54) REAL-TIME NETWORK DATA MANAGEMENT SYSTEM AND METHOD

(71) Applicant: Paul B. Hugenberg, III, Poland, OH (US)

(72) Inventor: Paul B. Hugenberg, III, Poland, OH (US)

(21) Appl. No.: 14/859,915

(22) Filed: Sep. 21, 2015

Related U.S. Application Data
(60) Provisional application No. 62/052,575, filed on Sep. 19, 2014.

(51) Int. Cl. H04L 12/24; G06F 17/30

(52) U.S. Cl. CPC H04L 41/12; G06F 17/30144; G06F 17/30377; G06F 17/30554

(57) ABSTRACT

One or more techniques and/or systems are disclosed for real-time data management on a computing network. A user can be provided with an ability to identify information about data, and updates to data, disposed on a network, such as a location of the data, a type of data, and a state of the data, in real-time. A processor component may be able to locally identify target records, and a monitor component can track the target records disposed in files on one or more devices in the network. Metadata about identified records can be indexed and stored in data management component. State changes on the targeted devices in the network can be identified in real-time and the appropriate updates can be provided to a user. A display component can provide a user with real-time information about target records as well as desired classifications and risk scores for targeted data and/or devices.

### CROSS-REFERENCE TO RELATED APPLICATIONS

This application claims priority to provisional patent application, U.S. Ser. No. 62/052,575, entitled REAL-TIME INFORMATION SYSTEM DISCOVERY AND FINGERPRINTING SYSTEM AND METHOD WITH OBJECTIVE TO CONTINUOUSLY INVENTORY AND INTERROGATE DATA CONTENT, CONTEXT, AND BEHAVIOR, filed Sep. 19, 2014, which is incorporated herein by reference.

### BACKGROUND

Periodically, network administrators may attempt to understand all of the information system components on their network, including an inventory of hardware, and estimation of data location and risk. Inventory of data and other information assets that exist in that hardware and software has been a process that may be required by law and regulation in some industries. Individual devices in a network may comprise hundreds of thousands of individual files, which makes it very difficult for an individual to identify information assets on a network comprising hundreds of devices.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

As provided herein, systems and techniques that can provide a user with an ability to identify information about data, and updates to data, disposed on a network, such as a location of the data, a type of data, and a state of the data, in real-time. For example, one may be able to locally identify and track records disposed in files on one or more devices in the network; and metadata about identified records can be indexed and stored in a remote database. State change on any of the targeted devices in the network can be identified in real-time, and appropriate updates provided. A display component can provide a user with real-time information about target records, as well as desired classifications and risk scores for targeted data and/or devices.

In one implementation, a system for real-time data management on a computing network can comprise a first monitoring component that is operably disposed on first machine in a network. The first monitoring component can be configured to, in real-time, identify a state change of the first machine. Further, the system can comprise a first state processing component, which is operably disposed on the first machine and communicatively coupled with the first monitoring component. The first state processing component can be configured to identify first machine update information based at least upon state change information received from the first monitoring component. Additionally, the first state processing component can be configured to prepare the first machine update information for transmission from the first machine to a remote data management component. In the example system, a display component can be operably coupled with the remote data management component, and configured to, in real-time, display at least a portion of the first machine update information in a user readable format to a user of the network.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

### BRIEF DESCRIPTION OF THE DRAWINGS

What is disclosed herein may take physical form in certain parts and arrangement of parts, and will be described in detail in this specification and illustrated in the accompanying drawings which form a part hereof and wherein:

FIG. 1 is a component diagram illustrating an example implementation of an exemplary system for real-time data management on a computing network.

FIG. 2 is a component diagram illustrating an example implementation of one or more portions of one or more components described herein.

FIG. 3 is a component diagram illustrating an example implementation of one or more portions of one or more components described herein.

FIG. 4 is a component diagram illustrating an example implementation of one or more portions of one or more components described herein.

FIG. 5 is a component diagram illustrating an example implementation of one or more portions of one or more components described herein.

FIG. 6 is a component diagram illustrating an example implementation of one or more portions of one or more components described herein.

FIG. 7 is a flow diagram illustrating an exemplary method for real-time data management on a computing network.

FIG. 8 is a component diagram illustrating an example environment where one or more portions of one or more components described herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices may be shown in block diagram form in order to facilitate describing the claimed subject matter.

In one aspect, a system may be devised that can provide a user with an ability to identify information about data disposed on a network, such as a location of the data, a type of data, and a state of the data, in real-time. Further, in one implementation, the system may provide the user with real-time updates on state changes that occur with user targeted data. As an example, a network user may wish to identify and track data of importance for a desired purpose (e.g., network security, intellectual property, personal and/or customer privacy, etc.). In one implementation, the system may be devised to identify and track records disposed in files on one or more devices in the network. In this implementation, the system may initially identify targeted records on respective machines in the network, and remotely store metadata about identified records in a database indexed to identify particular (e.g., desired) characteristics about the records. Further, in this implementation, the system may identify a state change on any of the targeted devices in the network, and interrogate the state change to identify whether any of the targeted records are affected by the state change. In this implementation, if a target record has been updated, or a new target record is identified, the updated information can be indexed and stored in the remote database. Additionally, in one implementation, the system may comprise a display component that provides a user with real-time information about target records, as well as desired classifications and risk scores for targeted data and/or devices.

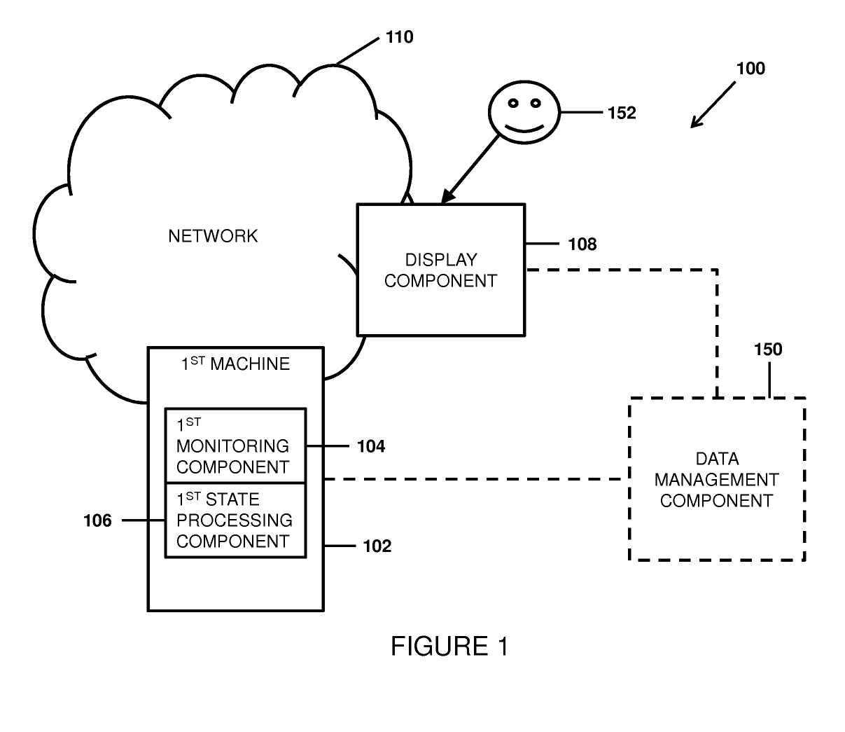

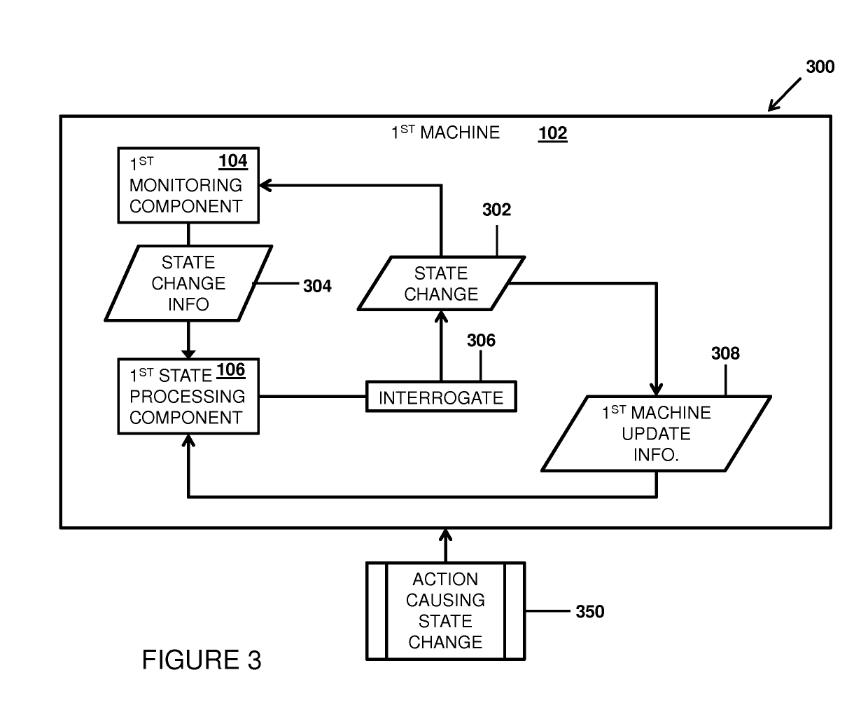

FIG. 1 is a component diagram illustrating an exemplary implementation 100 of a system for real-time data management on a computing network. In this exemplary implementation 100 a first monitoring component 104 can be operably disposed on first machine 102 (e.g., computing device, computer, tablet, mobile device, server, storage appliance, etc.) in a network 110 (e.g., local, wide area, storage area, enterprise private, global area, backbone, intranet, extranet, etc.). The first monitoring component 104 can be configured to identify a state change of the first machine 102, in real-time. As an example, as illustrated in the example implementation 300 of FIG. 3, a state change 302 of the first machine 102 may result from an action 350 on the first machine 102. In one implementation, an action 350 that causes a state change 302 may comprise a new installation of hardware, a change in user status, a new installation of software, a newly created file, a change to an existing file, and/or deletion of an existing file. In this example, when one of the example state changes occurs, the first monitoring component 104 can detect the state change 302, in real-time.

Returning to FIG. 1, in the exemplary implementation 100, a first state processing component 106 can be operably disposed on the first machine 102 and may be communicatively coupled with the first monitoring component 102. Further, as illustrated in the example implementation 300 of FIG. 3, the first state processing component 106 can be configured to identify first machine update information 308 based at least upon state change information 304 received from the first monitoring component 104. Additionally, the first state processing component 106 can be configured to prepare the first machine update information 308 for transmission from the first machine 102 to a remote data management component 150.

As an example, a state change 302 may occur on the first machine 102, resulting from some update to data on the machine. In one implementation, the first monitoring component 104 may utilize a message queue service (e.g., native or installed) to identify inter-process communication or inter-thread communication within a process. In this implementation, for example, the message queue service can comprise information relating to the passing of control or content, locally in a device, for example, which may be used by the first monitoring component 104 to identify the state change 302. Further, in this example, the first monitoring component 104 can identify a location (e.g., file location on the first machine) of the state change, a file name, and/or a file type for the state change 302. This information can be passed as state change information 304 to the first processing component 106.

In one implementation, the first processing component 106 can utilize the state change information 304 to locally interrogate 306 the data (e.g., file) comprising the state change 302. As an example, identifying desired information resulting from the state change 302 can comprise reading header information (e.g., file metadata) for the file identified by the first monitoring component 104. Further, in this example, the file may be opened and read locally using a file type reader identified from the file type information provided. Reading the file may identify changes to desired information, such as information target by a user of the network (e.g., important information desired to be tracked by the user. In one implementation, a result of the interrogation 306 may be first machine update information 308. As an example, the first machine update information 308 can comprise metadata yielded by the interrogation 306, such as a file name, type, state (e.g., created, accessed, changed, deleted), time/date info, user(s) creating/accessing (e.g., and more), as well as identification of a user targeted trackable record disposed in the file.

As an example, a network user (e.g., administrator) may wish to target data of a sensitive nature and/or may provide a potential security risk in the network, and can use the system to identify and track the targeted information. In this example, when a new record is accessed, created, changed and/or deleted, the file comprising the record can be interrogated to identify whether the record comprises the targeted information, and to identify other metadata related to the record (e.g., record type, file metadata, actions taken, users accessing, etc., whatever the user desires to track). Therefore, in one implementation, the first state processing component 106 may be used to identify current desired trackable information in the one or more records of a file, identify new desired trackable information in the one or more records of the file, and/or identify changes to desired trackable information in the one or more records of the file.

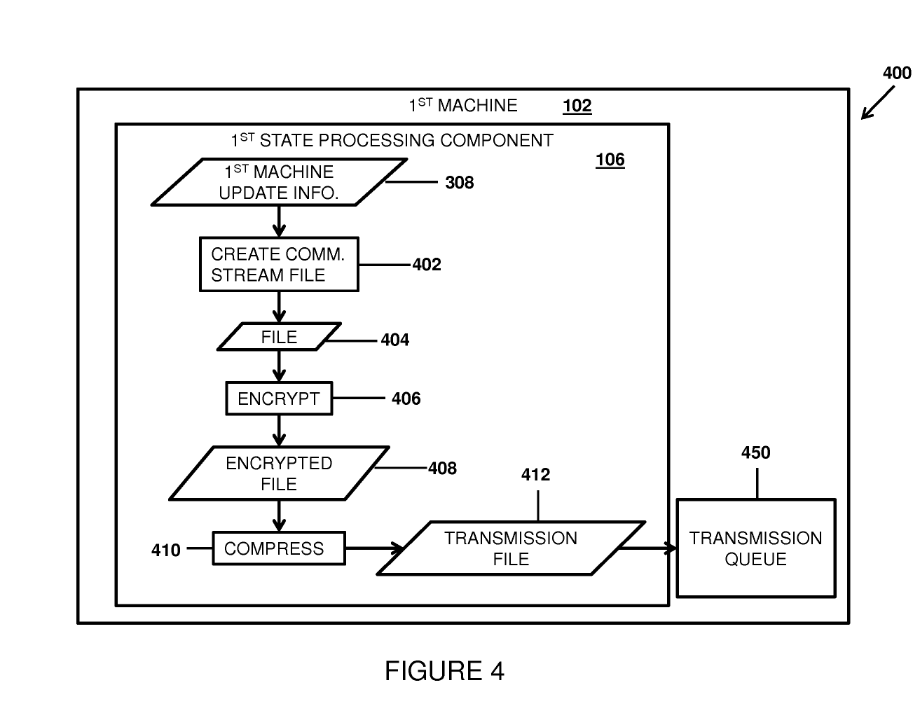

In one implementation, as illustrated in the example implementation 400 of FIG. 4, with continued reference to FIGS. 1 and 3, preparing the first machine update information 308 for transmission from the first machine 102 to the remote data management database 150, using the first state processing component 106, can comprise creating a communication stream file 404, at 402, where the resulting file 404 comprises the first machine update information 308 (e.g., the metadata indicative of the information about the targeted trackable record). Further, in this implementation, the communication stream file 404 can be encrypted 406 using any known encryption technique or system, chosen by sound judgement of one who practices in the art. Additionally, the resulting encrypted file 408 can be compressed 410, using any known compression technique or system, chosen by sound judgement of one who practices in the art. In this implementation 400, a resulting transmission file 412 (e.g., a communication stream file that has been encrypted and compressed) may be placed in a transmission queue 450 on the first machine 102, for example, for transmission to the remote data management database 150.

Returning to FIG. 1, the exemplary implementation 100 can comprise a display component 108 that is operably coupled with the remote data management component 150. The display component 108 can be configured to display at least a portion of the first machine update information 308 in a user readable format to a user 152 of the network 110, in real-time. As an example, the display component 108 may comprise components that can query the data management component 150 for information relating to targeted trackable records; and the display component can provide a user readable format of the requested (e.g., or automatically provided) information. As another example, a particular state change to a device in the network may involve a targeted trackable record, for which the user 152 desires to identify pre-determined (e.g., or any) state changes. In this example, the data management component 150 may provide the desired information as an alert to the display component 108, in real-time, such that the user 152 may be automatically alerted and provided with the information (e.g., so that they may be able to act on the information as quickly as possible).

In another example, the user may request desired information regarding targeted records, files, devices, systems, etc. in the network, and the display component can provide the requested information in a user readable format in real-time. In one implementation, the display component 108 may comprise a portal access point that provides access to a portal in the data management component. In this implementation, for example, a user 152 may access the portal access point using a global network such as the Internet. In this way, for example, the user may utilize a web-based application that allows the user to query the data management component for various information about targeted trackable records, state changes, files, and other data information (e.g., metadata) for the network 110. In this example, the requested information may be provided, in real-time, to the user 108 of the network 110, such as on a display (e.g., computer screen, tablet, mobile device, etc.).

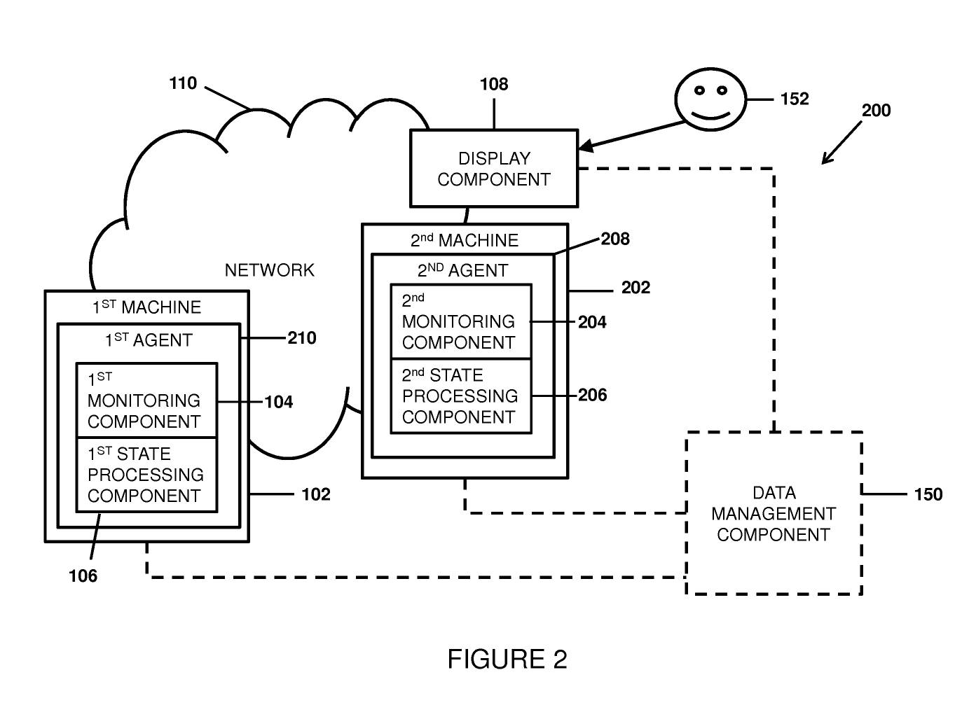

In one implementation, as illustrated in the example implementation 200 of FIG. 2, an example system can comprise a first agent 210 disposed on the first machine 102. In this implementation, the first agent 210 can comprise the first monitoring component 104 and the first state processing component 106. Further, the example system can comprise a second agent 208 disposed on a second machine 202 in the network 110. In this implementation, the second agent 208 can comprise a second monitoring component 204 and a second state processing component 206. Additionally, in another implementation, a third agent, fourth agent, fifth agent, etc., may be disposed on a third, fourth, fifth, etc. machine in the network, respectively, where respective agents comprise corresponding monitoring components and state processing components.

That is, for example, a user (e.g., administrator) of the network 110 may target particular devices and machines (e.g., all, and/or those that may comprise target records) for inclusion is a system that provides real-time data management on for the computing network 110. In this example, an agent comprising a corresponding monitoring component and state processing component may be loaded on to the respective target devices or machines. Further, in this implementation, for example, respective target machines may identify target trackable records disposed on the instant device and monitor for state changes that occur on the device, as described above. Additionally, as described above, when a state change occurs, the instant device may identify the state change, interrogate the state change, prepare a communication stream file indicative of the state change, and transmit it to the remote data management component. In turn, in this example, the display component (e.g., or more than one display component) may provide a user of the network with real-time information about the records, and/or state changes in the respective target devices in the network.

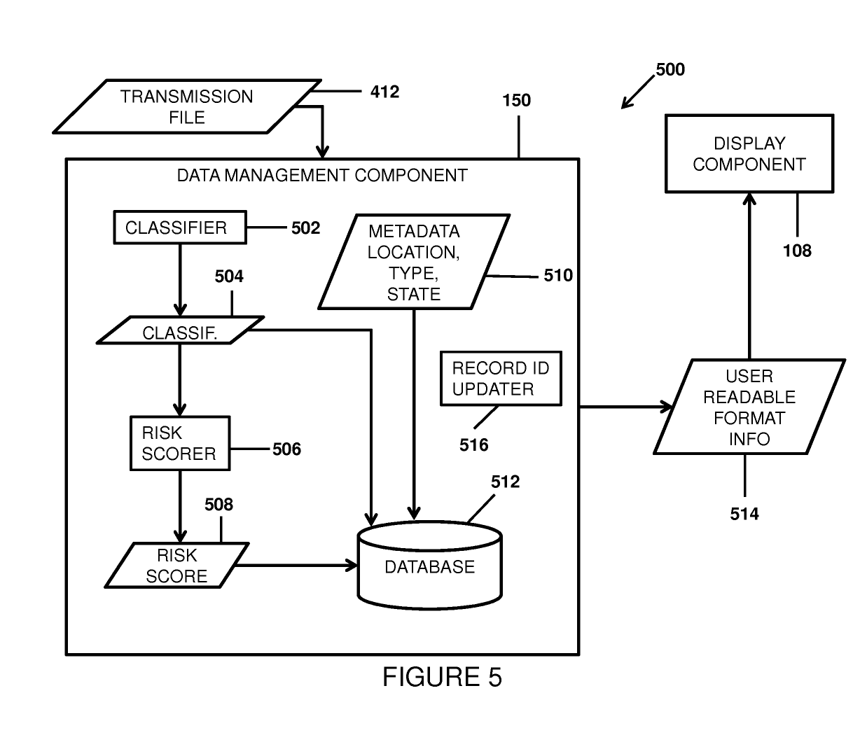

FIG. 5 is a component diagram illustrating an example implementation 500 of one or more portions of one or more systems described herein. With continued reference to FIGS. 1-4, in this implementation, the remote data management component 150 can comprise a classifier 502 that comprises an editable rule structure. The classifier 502 can be configured to provide a classification 504 for a desired trackable record that is indicated in the first machine update information 308, based at least upon a pre-determined classification scheme. Further, the remote data management component 150 can comprise a risk scorer 506 that is communicatively coupled with the classifier 502. The risk scorer 506 can be configured to assign a risk score 508 to the desired trackable record indicated in the first machine update information 308 provided to the classifier 502, based at least upon the classification 504 provided by the classifier 502.

As an example, the classifier 502 can comprise a rule-based decision structure that can be used to classify a record into one (e.g., or more) of a set of pre-determined classifications. For example, a base classification scheme may comprise classifications for “confidential,” “strategic,” “internal,” and “public.” In this example, the respective classification can be pre-determined, based on a user's preference and the rule-based decision structure can be created to meet those preferences. Further, for example, the risk scorer 506 can comprise a scoring structure that can be used to assign a risk score 508 to a record, based on the classification 504 assigned by the classifier 502. That is, for example, respective target records (e.g., indicated by metadata provided in the transmission file 412) can be provided with a classification 504 and a risk score 508.

Additionally, metadata indicative of the characteristics of the record 510, such as location, file type, record type, record state, etc., may be provided by the transmission file 412 to the data management component 150, as described above. In one implementation, the metadata indicative of the characteristics of the record 510 can be indexed by and stored in a database 512 disposed in the data management component 150. In this implementation, the classification 504 and a risk score 508 associated with a target trackable record may also be indexed by and stored in the database 512. In this way, for example, a user readable format 514 of information relating to a target trackable record (e.g., or a state change) can be provided to the display component 108, for use by a user of the network, as described above.

In one implementation, the remote data management component 150 can be configured to perform real-time classification of the respective one or more desired trackable records (e.g., target records). Further, the remote data management component 150 can be configured to perform real-time risk scoring of the respective one or more desired trackable records based at least upon the classification. That is, for example, as records are added, changed, accessed, and/or deleted, a user of the network may be provided with real-time classifications and risk scores for the respective target records.

As an example, a file comprising the following records: a person's name (e.g., classified as “public”), their email address (e.g., classified as “public”) and their social security number (e.g., classified as “strategic”), may have a risk score assigned to each record and a risk score calculated for the file, based at least upon the risk score of respective records and the number of records present. In this example, the user can access the real-time information about the records and file, and if changes are made to any of the records (e.g., the SSN is deleted, or the email is changed to an actual address), reclassification and updated risk scoring can occur. Upon the state change to the file and/or records, the user may be able to access (e.g., or be alerted of) the updated information (e.g., reclassifications and/or risk scores).

Additionally, in one implementation, as a file comprising target records can be assigned a risk score, for example, based on a number of records and risk scores assigned to respective records (e.g., or some other risk calculation), a risk score for a device may also be calculated. As an example, a risk score can be assigned to respective files on the device, and the device risk score may be calculated using the file risk score and the number of files disposed on the device that comprise risk scores.

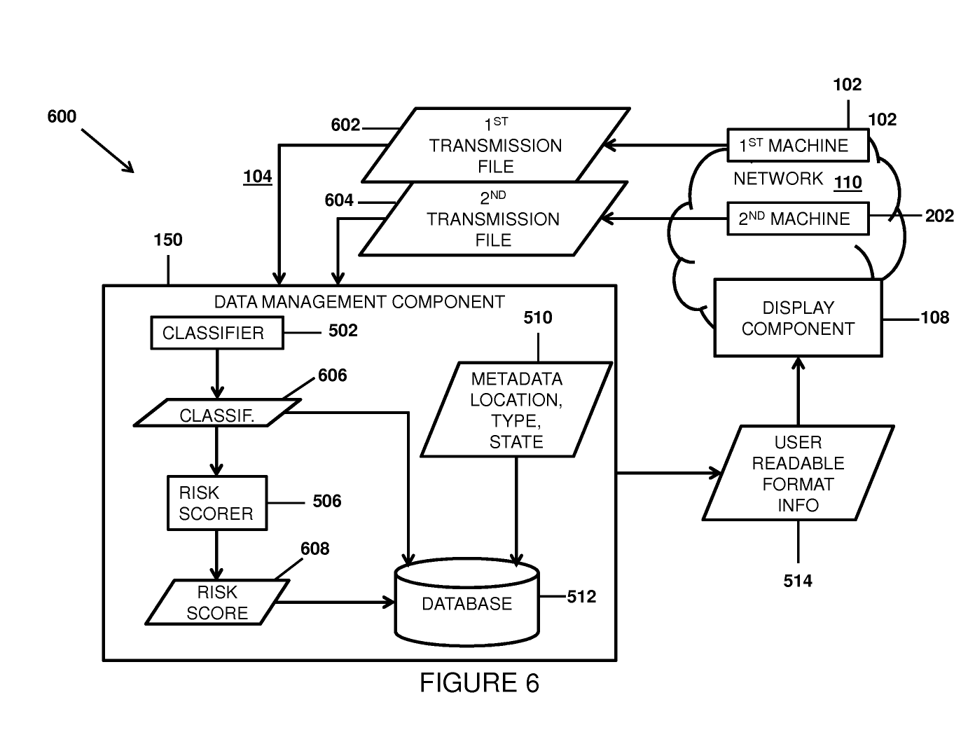

In another implementation, as illustrated in the example implementation 600 of FIG. 6, with continued reference to FIGS. 1-5, risk scores may be calculated for various combinations of devices in the network, such as in particular locations of a network (e.g., geographic local, department), and/or based on use (e.g., mobile, storage, type of data stored, etc.). In this way, for example, a user of the network may be able to identify and quantify potential risks for the network, and plan or take mitigate actions to improve (e.g., lower) potential risks. In this implementation, respective machines, such as the first machine 102 and the second machine 202 in the network 110 can provide a first transmission file 602 and second transmission file 604, respectively. In this example, 600, the metadata 510 related to respective records from respective transmission files 602, 604 can be indexed and stored in the database 512. Further, a classification 606 and risk score 506 can be provided for respective records from respective machines 102, 202, and indexed and scored by the database 512. The display component may be able to provide a user readable version of the classification and risk score for the respective records, files, devices 102, 202, and/or combination of devices on the network 110.

In one implementation, upon initiation of the first state processing component 106, on the first machine, the first state processing component 106 can be configured to scan the first machine for one or more desired (e.g., user targeted) trackable records. Further, in this implementation, the upon initiation of the first state processing component 106, on the first machine, the first state processing component 106 can be configured to identify metadata that is indicative of the respective one or more characteristics of an identified desired trackable record (e.g., comprising sensitive information). Additionally, after the initial identification of the desired trackable records and identification of the metadata, the first state processing component 106 can be configured to create a communication stream file (e.g., 412) comprising metadata indicative of the respective one or more characteristics of initially identified trackable records for transmission from the first machine 102 to the remote data management component 150. In this way, for example, when a new device is added to the network 110, those trackable records targeted by the user can be identified, and appropriate metadata, classifications, and/or risk scores may be indexed and stored in the database 512.

In one implementation, as illustrated in the example implementation 500 of FIG. 5, the remote data management component 150 can comprise a record identification updating component 516. The record identification updating component 516 can be configured to update record identification rules for the state processing component (e.g., 106, 206) in accordance with an updated rule structure in the remote data management component 150. As an example, a user of the network may identify an updated classification scheme, risk scoring scheme, and/or new/different target records. In this example, the new rules may be provided to the data management component 150, and the record identification updating component 516 can be used to push the new rules to (e.g., edit the rules on) the state processing component (e.g., 106, 206).

In one aspect, a method may be devised that allows a user to identify information about data disposed on a network, such as a location of the data, a type of data, and a state of the data, in real-time. Further, in one implementation, the method may allow the user to receive real-time updates on any state changes that occur with user targeted data. As an example, a user may wish to target data for security and/or privacy purposes. In one implementation, targeted records found in files on one or more devices in the network can be identified and tracked for state changes. Meta data indicative of the target records can be remotely indexed and stored in a database. Further, when a state change is identified on any of the targeted devices in the network, the state change can be interrogated to identify whether any of the targeted records are affected by the state change. In this implementation, the updated information can be indexed and stored in the remote database. Additionally, the user may be able to access real-time information about the target records and/or state changes, including alerts, from a display component; which may also provide access to desired classifications and risk scores for targeted records and/or devices.

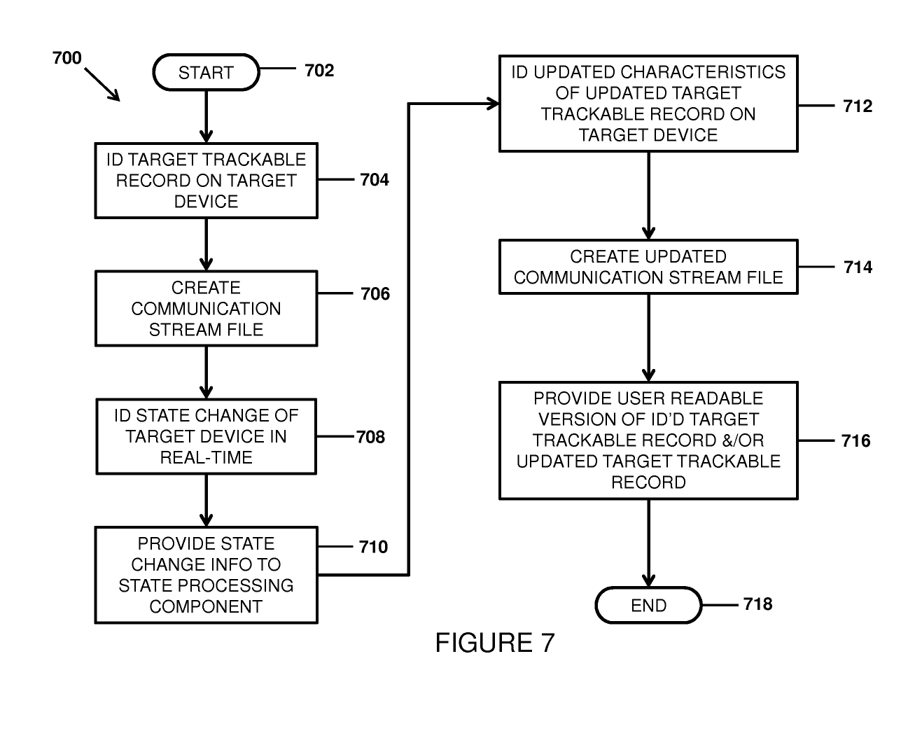

FIG. 7 is a flow diagram illustrating an exemplary method 700 for real-time data management on a computing network. The exemplary method 700 begins at 702. At 704, a state processing component is used to identify a target trackable record on a target device in a network. The target trackable record can comprise information targeted by a first user of the network and located in a file disposed on the target device. For example, the user may identify desired trackable records, which they wish to initially identify on devices in the network, and continue to monitor for state changes on an ongoing basis. At 706, a communication stream file can be created, where the communication stream file comprises metadata indicative of one or more characteristics of the identified target trackable record in real-time. The communication stream file can be configured to be transmitted to a remote data management component. For example, metadata that identifies characteristics of the identified targeted records can be prepared in a transmission file that is sent to the remote data management component, where it may be indexed and stored.

At 708, a state monitoring component can be used to identify a state change of the target device, in real-time. State change information can be provided to the state processing component, where the state change information comprises one or more of: a location of the state change, a file name of a file comprising the state change, and a file type of the file comprising the state change. That is, for example, the state monitoring component can monitor a local messaging queue to identify state changes. In this example, information about the state change can be passed to the state processing component in real-time, at 710.

At 712, the state processing component can use the state change information to identify one or more updated characteristics for an updated target trackable record on the target device. The updated target trackable record can comprise a changed state from a prior iteration of the updated target trackable record. That is, the state processing component can identify updated metadata associated with the record, where the updated metadata is indicative of the state change, such as a record change, deletion, addition, access, etc. At 714, an updated communication stream file can be created. The updated communication stream file can comprise the metadata indicative of one or more updated characteristics of the identified updated target trackable record in real-time, where the updated communication stream file configured to be transmitted to the remote data management component. That is, for example, updated information about a target record can be sent to the remote data management component to update the database.

At 716, a user readable version of the one or more characteristics of the identified target trackable record, and/or the one or more updated characteristics of the identified updated target trackable record, can be provided in real-time to a second user of the network. That is, for example, a user of the network may be able to access a user readable version of the characteristics of a target record, in real-time, including any updates, changes, deletions, additions, movement of, access to, etc. The exemplary method 700 ends at 718.

In one implementation, in an example implementation of the exemplary method 700, a classifier disposed on the remote data management component may be used to provide a classification for an identified target trackable record, which has been identified for a target device. In this implementation, the classification can be based, at least upon, a pre-determined classification scheme. That is, for example, a classification scheme may be devised, such as by a user (e.g., administrator) of the network, based on the user's desired target records and desired classification of identified records. Further, in one implementation, a risk scorer, which is communicatively coupled with the classifier, can be used to assign a risk score to the identified target trackable record identified for the target device provided to the classifier. The risk score assignment can be based, at least upon, the classification provided by the classifier. That is, for example, a risk score structure can be created by a user of the network, and the risk scorer may use the risk score structure to assign risk scores to records based upon the classification of the record.

In one implementation, the in an example implementation of the exemplary method 700, a user readable version of a risk score can be provided to the second user of the network, in real-time. That is, for example, the classification and/or risk score may be indexed and stored in a remote database of the remote database component for respective records, based at least upon a first user's desired selection of targeted records, classification scheme, and/or risk score structure. In this example, the second user may be able to access characteristics of a desired target record, such as state, type, locations, etc., along with a classification and risk score.

As an illustrative example, the system and/or method may comprise introducing an agent (e.g., software) into the network, by distributing it to each of the machines that they wish to monitor or interrogate for content. In this example, the agent may be distributed to every machine and can physically exist on every computer, laptop, server or other device communicating with the network. As an example, the agent can load two services, a monitor and a processor. In this example, the processor is installed is granted administrative rights to the end machine, therefore, it has the ability to perform a basic scan of the entire machine and record the natural operating system attributes called metadata, identifying what is loaded on that machine, what kind of machine it is, what's running on that machine, how many users are on that machine; which may be available just as an admin querying the operating system for that information.

In this example, the agent is imbedded with a list of file types that it knows may contain user targeted data. These file types and file type reader for specific file types can be pre-loaded in the agent. For example, when the agent activated on a machine it can pull down the existing file types with which it is loaded, after it goes through the metadata collection, and can identify and interrogate the identified file. When the agent identifies a file, it opens up the header and identifies metadata for the file, such as the type of file. The agent can also review file type listings against its inventory of file type readers and if there's a match, it will open up that file in memory and will begin to do a line by line scan, or cell by cell scan, of the contents of that line or that cell. When the agent reads the line it can compare the contents of that line or that cell to whatever rules the user has assigned to that agent.

Once that processor does the scanning and reading, the processor can then take that information and creates a little communication stream. As an example, a communication stream can comprise a “JSON” file; the processor takes the metadata information and writes it in JSON format; then it can encrypt and compress the JSON file into a “GZIP” file, for example. In this example, the GZIP filed can be sent to a destination which is coded the back-end cloud, comprising the data management component for that particular user.

Further, in this illustrative example, the monitor, the second service, can utilize a message queuing, such as the native service MSMQ. MSMQ is a message carrying system within the Microsoft operating world that listens for changes to anything on the system, for example, loading new hardware, opening a file, changing a file, etc. The monitor acts as a listener that uses MSMQ to listen through the monitoring service. In this example, the monitoring service will load a change (e.g., on the queue stack), such as when a document is opened, changed and saved. The monitor, through the message que, will identify the new file creation and it will notify the processor of the location, the file name, the file type; then the processor can interrogate the location. The processor can then review the file type, immediately interrogate that file, create the JSON, GZIP it and send it back to the cloud. So the monitor, as a service, listens for any changes in the network and then sends it back to the data management component.

In the illustrative example, the data management component can comprise a database that indexes and stores all of the metadata provided by the respective devices in the network. As an example, the data management component can comprise a sequel database that takes all those codes that come back in the JSON file and write them to their appropriate tables in the sequel database. Further for example, an integrated development environment (IDE) (e.g., visual studio) may be used to call the sequel database and present that information to the user in clear text format and not coded format. The database can comprise the classifier that classifies the received information as any way the user wants it to be classified. For example, when the processor identifies a record, it found the record because it's in a file type that it has a reader for and there is a rule that says search for this stuff and it has found it and it's created that tag. In this example, a JSON file returns to the data management component, it gets indexed and stored by the sequel database, and the sequel database calls the classifier to provide a classification in accordance with the pre-determined rules. A risk score can then be calculated for the classification based on a pre-determined rules set, such as determined by the user.

Further, in this example, the rule set in the data management component may be updated. For example, if the user wanted a name across the network, they could add that language to the rule set in a compartmentalized area that drives the agent. In this example, when the agent is installed and continues to monitor, it will call the data management component from the client end periodically (e.g., once every two minutes; or may receive push notifications) and ask for the latest rule set. So when a new rule is added, the agent will download it to the machine; therefore, adding a new rule can happen at the data management component level.

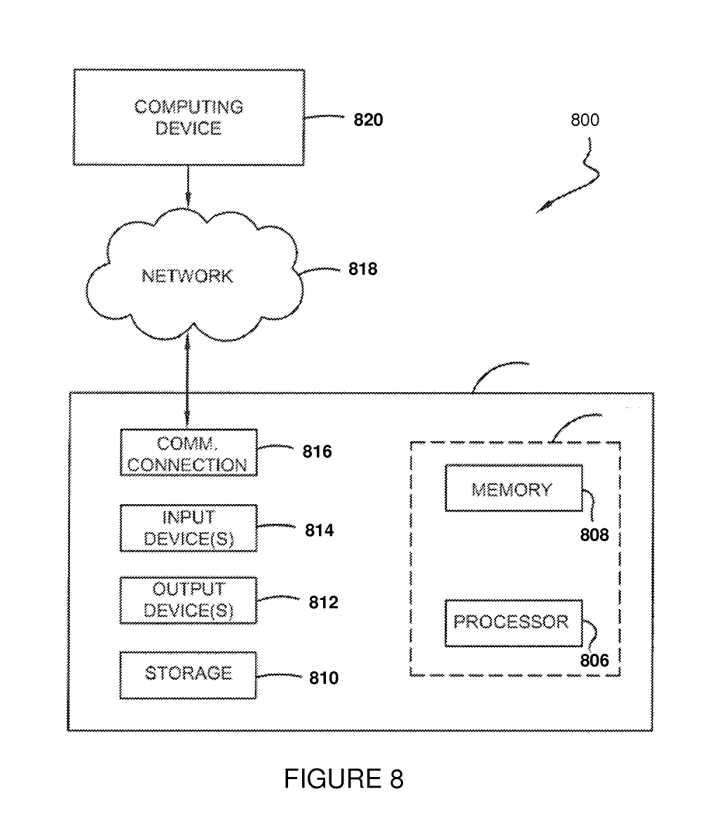

FIG. 8 and the following discussion provide a brief, general description of a computing environment in/on which one or more or the implementations of one or more of the methods and/or system set forth herein may be implemented. The operating environment of FIG. 8 is merely an example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, mobile consoles, tablets, media players, and the like), multiprocessor systems, consumer electronics, mini computers, mainframe computers, distributed computing environments that include any of the above systems or devices, and the like.

Although not required, implementations are described in the general context of “computer readable instructions” executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 8 illustrates an example of a system 800 comprising a computing device 802 configured to implement one or more implementations provided herein. In one configuration, computing device 802 includes at least one processing unit 806 and memory 808. Depending on the exact configuration and type of computing device, memory 808 may be volatile (such as RAM, for example), non-volatile (such as ROM, flash memory, etc., for example) or some combination of the two. This configuration is illustrated in FIG. 8 by dashed line 804.

In other implementations, device 802 may include additional features and/or functionality. For example, device 802 may also include additional storage (e.g., removable and/or non-removable) including, but not limited to, magnetic storage, optical storage, and the like. Such additional storage is illustrated in FIG. 8 by storage 810. In one implementation, computer readable instructions to implement one or more implementations provided herein may be in storage 810. Storage 810 may also store other computer readable instructions to implement an operating system, an application program and the like. Computer readable instructions may be loaded in memory 808 for execution by processing unit 806, for example.

The term “computer readable media” as used herein includes computer storage media. Computer storage media includes volatile and nonvolatile, removable and non-removable media implemented in any method or technology for storage of information such as computer readable instructions or other data. Memory 808 and storage 810 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 802. Any such computer storage media may be part of device 802.

Device 802 may also include communication connection(s) 816 that allows device 802 to communicate with other devices. Communication connection(s) 816 may include, but is not limited to, a modem, a Network Interface Card (NIC), an integrated network interface, a radio frequency transmitter/receiver, an infrared port, a USB connection or other interfaces for connecting computing device 802 to other computing devices. Communication connection(s) 816 may include a wired connection or a wireless connection. Communication connection(s) 816 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 802 may include input device(s) 804 such as keyboard, mouse, pen, voice input device, touch input device, infrared cameras, video input devices, and/or any other input device. Output device(s) 812 such as one or more displays, speakers, printers, and/or any other output device may also be included in device 802. Input device(s) 814 and output device(s) 812 may be connected to device 802 via a wired connection, wireless connection, or any combination thereof. In one implementation, an input device or an output device from another computing device may be used as input device(s) 814 or output device(s) 812 for computing device 802.

Components of computing device 802 may be connected by various interconnects, such as a bus. Such interconnects may include a Peripheral Component Interconnect (PCI), such as PCI Express, a Universal Serial Bus (USB), firewire (IEEE 1384), an optical bus structure, a wireless bus structure, and the like. In another implementation, components of computing device 802 may be interconnected by a network. For example, memory 808 may be comprised of multiple physical memory units located in different physical locations interconnected by a network.

Those skilled in the art will realize that storage devices utilized to store computer readable instructions may be distributed across a network. For example, a computing device 820 accessible via network 818 may store computer readable instructions to implement one or more implementations provided herein. Computing device 802 may access computing device 820 and download a part or all of the computer readable instructions for execution. Alternatively, computing device 802 may download pieces of the computer readable instructions, as needed, or some instructions may be executed at computing device 802 and some at computing device 820.

The word “exemplary” is used herein to mean serving as an example, instance or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, at least one of A and B and/or the like generally means A or B or both A and B. In addition, the articles “a” and “an” as used in this application and the appended claims may generally be construed to mean “one or more” unless specified otherwise or clear from context to be directed to a singular form.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. Of course, those skilled in the art will recognize many modifications may be made to this configuration without departing from the scope or spirit of the claimed subject matter.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure.

In addition, while a particular feature of the disclosure may have been disclosed with respect to only one of several implementations, such feature may be combined with one or more other features of the other implementations as may be desired and advantageous for any given or particular application. Furthermore, to the extent that the terms “includes,” “having,” “has,” “with,” or variants thereof are used in either the detailed description or the claims, such terms are intended to be inclusive in a manner similar to the term “comprising.”

What is claimed is:

1. A system for real-time data management on a computing network, comprising:
a first monitoring component operably disposed on first machine in a network, the first monitoring component configured to, in real-time, identify a state change of the first machine;
a first state processing component, operably disposed on the first machine and communicatively coupled with the first monitoring component, the first state processing component configured to:
identify first machine update information based at least upon state change information received from the first monitoring component; and
prepare the first machine update information for transmission from the first machine to a remote data management component; and
a display component operably coupled with the remote data management component, and configured to, in real-time, display at least a portion of the first machine update information in a user readable format to a user of the network.

2. The system of claim 1, comprising:
a first agent disposed on the first machine, the first agent comprising the first monitoring component and the first state processing component; and
a second agent disposed on a second machine in the network, the second agent comprising a second monitoring component and a second state processing component.

3. The system of claim 1, the state change of the first machine comprising one or more of:
a new installation of hardware;
a change in user status of the first machine;
a new installation of software;
a newly created file;
a change to an existing file; and
deletion of an existing file.

4. The system of claim 1, the state change information comprising one or more of:
a location of the state change on the first machine;
a file name; and
a file type.

5. The system of claim 1, the first state processing component identifying the first machine update information comprising one or more of:
interrogating one or more records of a file at a location of the state change on the first machine;
identifying current desired trackable information in the one or more records of the file; and
identifying new desired trackable information in the one or more records of the file; and
identifying changes to desired trackable information in the one or more records of the file.

6. The system of claim 1, the first state processing component preparing the first machine update information for transmission from the first machine to a remote data management database comprising one or more of:
creating a communication stream file comprising the first machine update information;
encrypting the communication stream file;
compressing the communication stream file; and
placing the communication stream file in a queue on the first machine for transmission to the remote data management component.

7. The system of claim 1, the first machine update information comprising metadata indicative of a state of one or more desired trackable records on the first machine.

8. The system of claim 7, the remote data management component configured to perform one or more of:
real-time classification of the respective one or more desired trackable records; and
real-time risk scoring of the respective one or more desired trackable records based at least upon the classification;
real-time risk scoring of respective devices on the network;
real-time risk scoring of one or more combinations of devices on the network; and
identification of a location, type, state, classification, and/or risk score of respective desired trackable records on one or more devices on the network.

9. The system of claim 1, the remote data management component comprising a classifier comprising an editable rule structure, and configured to provide a classification for a desired trackable record indicated in the first machine update information, based at least upon a pre-determined classification scheme.

10. The system of claim 9, the remote data management component comprising a risk scorer communicatively coupled with the classifier, and configured to assign a risk score to the desired trackable record indicated in the first machine update information provided to the classifier, based at least upon the classification provided by the classifier.

11. The system of claim 1, the first state processing component, upon initiation on the first machine, configured to:
scan the first machine for one or more desired trackable records;
identify metadata indicative of respective one or more characteristics of an identified trackable record; and
create a communication stream file comprising metadata indicative of respective one or more characteristics of an identified trackable record for transmission from the first machine to the remote data management component.

12. A system for real-time data management on a computing network, comprising:
a remote data management component, disposed remotely from, and communicatively coupled with, respective one or more target devices in a network, the remote data management component configured to:
receive a first communication stream file from a first target device in the network, the first communication stream file comprising metadata indicative of one or more characteristics of an identified trackable record on the first target device, the identified trackable record on the first target device identified by a state processing component disposed on the first target device;
received a second communication stream file from the first target device, the second communication stream file comprising metadata indicative of one or more characteristics of an updated identified trackable record on the first target device, the one or more characteristics of the updated identified trackable record identified in real-time by the state processing component disposed on the first target device based at least upon state change information provided to the state processing component disposed on the first target device by a monitoring component operably disposed on first machine, the monitoring component on first machine identifying the state change information indicative of a state change of the first machine in real-time; and
provide a user readable format, in real-time, of the one or more characteristics of the identified trackable record to a display component operably coupled with the remote data management component, for display to a user of the network.

13. The system of claim 12, the remote data management component comprising a classifier comprising an editable rule structure, and configured to provide a classification for an identified trackable record identified for the first target device, based at least upon a pre-determined classification scheme.

14. The system of claim 13, the remote data management component comprising a risk scorer communicatively coupled with the classifier, and configured to assign a risk score to the identified trackable record identified for the first target device provided to the classifier, based at least upon the classification provided by the classifier.

15. The system of claim 12, the remote data management component configured to perform one or more of:
real-time classification of the respective one or more identified trackable records; and
real-time risk scoring of the respective one or more identified trackable records based at least upon the classification;
real-time risk scoring of respective devices on the network;
real-time risk scoring of one or more combinations of devices on the network; and
identification of a location, type, state, classification, and/or risk score of respective desired trackable records on one or more devices on the network.

16. The system of claim 12, the remote data management component comprising a record identification updating component configured to update record identification rules for the state processing component in accordance with an updated rule structure in the remote data management component.

17. The system of claim 12, the state change of the first target device comprising one or more of:
a new installation of hardware;
a change in user status of the first machine;
a new installation of software;
a newly created file;
a change to an existing file; and
deletion of an existing file.

18. The system of claim 17, the state change information comprising one or more of:
a location of the state change on the first machine;
a file name; and
a file type.

19. A method for real-time data management on a computing network, comprising:
using a state processing component to identify a target trackable record on a target device in a network, the target trackable record comprising information targeted by a first user of the network and located in a file disposed on the target device;
creating a communication stream file comprising metadata indicative of one or more characteristics of the identified target trackable record in real-time, the communication stream file configured to be transmitted to a remote data management component;
using a state monitoring component to identify a state change of the target device, in real-time, and providing state change information to the state processing component, the state change information comprising one or more of: a location of the state change, a file name of a file comprising the state change, and a file type of the file comprising the state change;
using the state processing component to identify one or more updated characteristics for an updated target trackable record on the target device, the updated target trackable record comprising a changed state from a prior iteration of the updated target trackable record;
creating an updated communication stream file comprising metadata indicative of one or more updated characteristics of the identified updated target trackable record in real-time, the updated communication stream file configured to be transmitted to the remote data management component; and
providing a user readable version of one or both of the one or more characteristics of the identified target trackable record and the one or more updated characteristics of the identified updated target trackable record in real-time to a second user of the network.

20. The method of claim 19, comprising at least one of:
using a classifier disposed on the remote data management component to provide a classification for an identified target trackable record identified for the target device, based at least upon a pre-determined classification scheme;
using a risk scorer, communicatively coupled with the classifier, to assign a risk score to the identified target trackable record identified for the target device provided to the classifier, based at least upon the classification provided by the classifier; and
providing a user readable version of a risk score to the second user of the network, in real-time.
